(19) United States
(12) Patent Application Publication
(10) Pub. No.: US 2017/0008461 A1
(43) Pub. Date: Jan. 12, 2017

(54) ROOF RAILING FOR BEING DETACHABLY MOUNTED ON THE ROOF FRAME OF A MOTOR VEHICLE

(71) Applicant: GM GLOBAL TECHNOLOGY OPERATIONS LLC, Detroit, MI (US)

(72) Inventor: Marten WITTORF, Ruesselsheim (DE)

(73) Assignee: GM GLOBAL TECHNOLOGY OPERATIONS LLC, Detroit, MI (US)

(21) Appl. No.: 15/205,280

(22) Filed: Jul. 8, 2016

(30) Foreign Application Priority Data
Jul. 8, 2015 (DE) 202015004902.8

(51) Int. Cl. B60R 9/058

(52) U.S. Cl. CPC B60R 9/058

(57) ABSTRACT

A roof railing is provided for detachably mounting on the roof frame of a motor vehicle. The roof railing includes a longitudinally extending roof ledge and a longitudinally extending cover. The cover has an upper side that faces the roof ledge and an underside that faces away from the upper side. In the installed position on the motor vehicle, the underside of the cover preferably is in contact with and covers the roof frame of the motor vehicle body. The roof railing includes at least two mounting elements, which are spaced apart from one another in the longitudinal direction, on the underside of the cover. One or more cross members have ends configured to attach to the roof railing.

### CROSS-REFERENCE TO RELATED APPLICATION

This application claims priority to German Patent Application No. 202015004902.8, filed Jul. 8, 2015, which is incorporated herein by reference in its entirety.

### TECHNICAL FIELD

The present disclosure pertains to a roof railing detachably mounted on the roof frame of a motor vehicle. According to other aspects, a roof luggage rack arrangement and a motor vehicle equipped with such a roof luggage rack arrangement or with at least one such roof railing are provided.

### BACKGROUND

Roof rack arrangements for motor vehicles, particularly for passenger cars, are well known from the prior art. Various types of motor vehicles, particularly Sport Utility Vehicles (SUV) and caravan or station wagon versions of passenger cars, are provided with longitudinally extending roof railings on the lateral roof frames of the motor vehicle body. These roof railings typically are rigidly and inseparably connected to the roof frame. Roof railings of this type, which are rigidly arranged on the motor vehicle body, particularly serve for mounting a load carrier that may be formed, for example, by detachably arranging two crosspieces on the longitudinally extending roof railings such that they are spaced apart from one another in the longitudinal direction of the vehicle. Load carrier systems of this type can be used, for example, for carrying along bicycles or roof boxes.

In various motor vehicles, railings extending in the longitudinal direction of the motor vehicle also are increasingly provided on the lateral roof edges for optical reasons. For example, laterally spaced roof railings extending in the longitudinal direction of the vehicle are sometimes intended to provide a motor vehicle with a distinctly sporty design. However, roof railings provided for mere design reasons are frequently not suitable for the attachment of a load carrier system. Consequently, they only serve as a trim component and are not designed for the load-transmitting arrangement of a load carrier system on the roof structure of a motor vehicle.

The realization of different roof railings, which are either provided for the installation of a roof rack system, for optical reasons or for vehicle design reasons, requires a corresponding geometric adaptation of the roof structure, particularly the side roof frame of the motor vehicle body.

### SUMMARY

One aspect of the present disclosure provides a roof railing solution that makes it possible to give the vehicle roof different forms of appearance without requiring modifications of the roof frame of the motor vehicle body. The present disclosure particularly provides a specific adaptation of the motor vehicle roof to different requirements and individual preferences of end customers without requiring modifications of the car body shell, particularly the roof frame of the car body. It should be possible to realize the proposed solution as cost-efficiently as possible and to provide the motor vehicle with noticeable added value. It should furthermore be possible to optionally adapt or reconfigure the roof railing in accordance with customer specifications after the final assembly of the motor vehicle.

Accordingly, a roof railing for detachably mounting on the roof frame of a motor vehicle is provided. The roof railing includes a longitudinally extending roof ledge, as well as a longitudinally extending cover. The cover has an upper side that faces the roof ledge and an underside that faces away from the upper side. In the installed position on the motor vehicle, the underside of the cover preferably is in contact with and covers the roof frame of the motor vehicle body. The roof railing furthermore includes at least two mounting elements, which are spaced apart from one another in the longitudinal direction, on the underside of the cover.

The externally visible roof ledge can be detachably mounted on the roof frame of the motor vehicle by the at least two mounting elements. In this case, the cover located between the mounting element and the roof ledge covers the detachable connection of the roof railing on the roof frame of the motor vehicle body. The roof railing may be configured in the form of an optional accessory part or accessory equipment for the motor vehicle and already be rigidly connected to the motor vehicle during the course of its final assembly depending on customer preferences. Since the roof railing would be detachably mounted to the roof frame in this case, it could be detached and removed from the roof frame of the motor vehicle body, as well as substituted with a roof railing of different design, either by the respective end users themselves or with the aid of a suitable tool.

Due to the detachable mounting concept for a roof railing extending in the longitudinal direction of the motor vehicle, an installed roof railing can also be replaced with a different type of roof railing. In this way, the appearance of the motor vehicle can be changed at any time in accordance with personal preferences by subsequently replacing a roof railing. It would furthermore be conceivable that the longitudinally extending roof railing is only mounted on the roof frame of the motor vehicle body when it is needed for the transport of loads to be arranged on the vehicle roof similar to a roof luggage rack system.

According to another embodiment, the mounting elements are structurally connected to the roof ledge. In the present context, a structural connection refers to a load-transmitting connection between the mounting element and the roof ledge. Due to the structural connection to the mounting elements, the roof ledge can be mounted on the roof frame of the motor vehicle body in a rigid and load-transmitting fashion. In this way, the longitudinally extending roof ledge may serve for assembling a load carrier system, e.g. for installing one or more crosspieces of a roof rack.

According to another embodiment, the connection between the roof ledge and the mounting element penetrates a recess of the cover. The structural connection between the roof ledge and the mounting elements provided for mounting the roof railing on the roof frame therefore extends through the cover. However, the cover itself does not have to absorb or transmit any loads to adjacent vehicle components. In this respect, the cover merely serves for concealing the mounting elements and the detachable mounting of the roof railing on the roof frame of the vehicle body.

According to another embodiment, the cover has a shell-like contour that is adapted to the lateral roof frame of the motor vehicle. In this case, the contour of the cover can be adapted to the contour of the lateral roof frame in a precisely fitted fashion. Essentially the entire surface of the cover particularly may be in contact with the roof frame if the roof railing is mounted on the roof frame by the at least two mounting element.

The cover particularly may extend between the mounting elements, which are spaced apart from one another in the longitudinal direction, in one piece. In this respect, the cover may include a one-piece covering shell that extends continuously in the longitudinal direction and outwardly conceals the at least two mounting elements.

According to another embodiment, the cover includes a plastic shell or a sheet metal shell. In this respect, the cover may be realized, e.g., in the form of a formed sheet metal part or an injection-molded plastic part. In this way, the shell can be manufactured in a particularly cost-efficient fashion and with any geometric shape. Since the cover is designed and specifically realized in the form of a plastic shell or sheet metal shell, it can be adapted to various design and geometry requirements in a particularly simple fashion.

According to another embodiment, the roof ledge is spaced apart from the cover. In this way, a clearance is formed between the longitudinally extending roof ledge and the cover extending predominantly parallel thereto. The clearance can simplify, for example, the installation of additional crosspieces for a roof rack system. In this case, the roof ledge is connected to the at least two mounting elements by at least two connecting webs that penetrate the cover. The connecting webs may be realized integrally with the roof ledge. The roof ledge is preferably realized in the form of a metal profile. The connecting webs particularly may act as base points of the roof ledge, by which the roof ledge is structurally connected to the mounting elements.

The roof ledge includes at least two mounting elements. However, it may also be provided with three or even more mounting elements. The roof ledge may accordingly include a number of connecting webs that corresponds to the number of mounting elements. In this way, the roof ledge can be structurally mounted on the roof frame multiple times by respectively individual connecting webs and the mounting elements connected thereto.

According to another embodiment, the mounting elements respectively include a holding clamp that corresponds to a mounting structure of the roof frame. Each of the mounting elements can be detachably connected to a mounting structure of the roof frame provided for this purpose positively and/or non-positively, particularly in a clamped fashion, with the aid of such a holding clamp.

According to an enhancement, it is provided that the holding clamp includes an upper limb and a lower limb. In this case, the location or position of the upper and the lower limb relative to one another respectively can be variably adjusted and fixed by a fixing device. The holding clamp particularly may have a C-shaped cross-sectional contour. The upper and the lower limb form the opposite ends of the C-shaped contour. Since the limbs are designed such that they can be moved relative to one another, as well as fixed relative to one another and locked in a final installation position by the fixing device, a positive or clamped load-transmitting connection is produced between the mounting element and the mounting structure of the motor vehicle body provided for this purpose. It is particularly provided that the holding clamp of a mounting element at least sectionally encloses or encompasses a mounting structure of the roof frame that includes at least one undercut.

According to another aspect, the present disclosure provides a roof railing set including at least two roof railings of the above-described type. These roof railings respectively include identical mounting elements that are also positioned identically relative to one another. However, the roof ledges or the covers of two roof railings forming a roof railing set differ from one another. It would furthermore be conceivable that two roof railings of a roof railing set differ from one another with respect to their roof ledge, as well as with respect to their cover. The roof railings or the covers of different roof railings of the roof railing set may respectively differ from one another with respect to their geometry, shape, extent, color, material and surface quality.

The motor vehicle can be individualized in accordance with customer specifications by selecting a certain roof railing of an available roof railing set and installing the selected roof railing on the motor vehicle. Furthermore, customers can replace an installed roof railing with a different type of roof railing of the roof railing set at will, namely either themselves or by visiting a service workshop.

According to another aspect, the present disclosure furthermore provides a roof rack arrangement with at least two roof railings of the above-described type that are arranged parallel to one another and spaced apart from one another perpendicular to their longitudinal direction. In addition to the two roof railings, the roof rack arrangement includes one or more crosspieces that extend between the roof railings. This crosspiece(s) respectively can be structurally connected or is connected to one of the roof railings with opposite end sections. In their final installation position on the motor vehicle, the roof railings typically extend in the longitudinal direction (x) of the vehicle, whereas the crosspiece(s) typically extends perpendicular thereto, namely in the lateral direction (y) of the vehicle.

In this context, the crosspiece(s) may lie in the same plane as the roof ledges of the roof railings. However, it would also be conceivable that the crosspiece(s) is arranged above or underneath the roof ledges of the two roof railings referred to the vertical direction (z) of the motor vehicle. The crosspiece(s) particularly may also be arranged such that it lies on top of the roof ledges. It may furthermore slightly protrude over the roof ledges of the roof railings in the lateral direction of the vehicle with its opposite end sections.

A roof rack arrangement for accommodating and supporting roof loads is formed due to the structural connection between the roof railings and the crosspiece(s). For example, bicycle mounts or mounts for roof boxes may be arranged on the crosspiece(s) such that corresponding objects can be mounted on the roof rack arrangement and thereby transported on the roof of the motor vehicle.

The crosspiece(s) furthermore mutually supports the two opposite roof railings provided on the lateral edges of the roof. Any lateral forces acting upon one of the railings therefore can be transmitted to the respective opposite roof railing by the crosspiece(s). The parallel arrangement of roof railings is also structurally strengthened and correspondingly reinforced due to the connection to the crosspiece(s).

At least two crosspieces are typically provided and spaced apart from one another in the longitudinal direction of the roof railings such that the roof railings can be structurally connected to one another, for example, by a front and a rear crosspiece, i.e. crosspieces that are arranged forward and rearward referred to the driving direction. The structural rigidity of the roof rack arrangement, as well as its capacity for accommodating objects to be carried along, can be additionally increased by providing two or more crosspieces.

According to another embodiment, the crosspiece(s) is directly connected to at least one of the mounting elements of the roof railings. Since the crosspiece(s) respectively is directly connected to or mounted on the mounting elements of the roof railings provided on opposite ends of the crosspiece(s), an improved structural connection of the crosspiece(s) on the roof frame can be achieved. In this way, any forces applied to the roof rack arrangement or to be transmitted by the crosspiece(s) can be directly applied and transmitted to the roof frame of the motor vehicle body by the mounting elements.

It would furthermore be conceivable that the crosspiece(s) is rigidly and inseparably connected to the opposite roof railings, particularly to their mounting elements. In this respect, the roof rack arrangement may form a grating structure of sorts which consists of the at least two parallel roof railings and the crosspieces extending in between.

According to another embodiment, it would furthermore be conceivable that the crosspiece(s) is detachably connected to the roof railings. A detachable arrangement of the crosspiece(s) on the roof railings may be realized on the roof ledge, as well as on at least one of the mounting elements of the roof railing. In this way, two roof railings arranged on opposite sides of the roof frame can be respectively converted or transformed into a roof rack arrangement, which is suitable for mounting and carrying along roof loads on the motor vehicle, by optionally adding and installing one or more crosspieces.

According to another aspect, the present disclosure ultimate discloses a motor vehicle with a motor vehicle body that includes a lateral roof frame with at least two mounting structures. At least one of the above-described roof railings is arranged on the mounting structures that are spaced apart from one another in the longitudinal direction of the vehicle or at least one above-described roof rack is arranged on the roof frame if a total of four mounting structures are provided.

Due to the detachable mounting of the roof railing, the motor vehicle can be appropriately configured in accordance with customer specifications without requiring modifications of the roof frame or of the car body shell. The mounting structures of the roof frame are standardized in accordance with the arrangement of the corresponding mounting elements of the roof railing. Their position and their distance from one another are specified. Due to the detachable mounting of the roof railing on the roof frame of the motor vehicle, for example, a certain roof railing can be selected from a roof railing set and detachably mounted on the roof frame in order to configure a certain vehicle.

According to an enhancement, the mounting structures of the roof frame can be connected to at least one of the mounting elements of a roof railing positively and/or in a clamped fashion. The mounting structures of the roof frame particularly may be structurally reinforced such that any forces applied or transmitted to the roof frame by the railing or mechanical loads can be absorbed and/or diverted into the car body without deformations or damages of the roof frame.

According to another embodiment, it is ultimately proposed that the cover of the roof railing conceals at least the mounting structures of the roof frame in an installed position on the motor vehicle. These mounting structures, as well as the corresponding mounting elements of the roof railing provided on the underside of the cover, therefore are not visible from outside when the roof railing is mounted on the motor vehicle. Only the fixing device for detachably fixing or mounting the roof railing on the roof frame can be actuated from outside.

It would particularly be conceivable that the fixing device can be actuated or operated, for example, with a separate tool such as a wrench. For example, the fixing device particularly could be flushly integrated into the surface of the cover or concealed within the cover with the aid of a covering cap or the like.

### BRIEF DESCRIPTION OF THE DRAWINGS

The present disclosure will hereinafter be described in conjunction with the following drawing figures, wherein like numerals denote like elements.

FIG. 1 shows a schematic side view of a motor vehicle;

FIG. 2 shows a cross section through a roof railing arranged on the roof frame of the motor vehicle:

FIG. 3 shows a schematic perspective view of the roof railing prior to its installation on the roof frame;

FIG. 4 shows a perspective view corresponding to FIG. 3, however, with a roof railing arranged on the roof frame; and

FIG. 5 shows a schematic view of a roof rack arrangement including two roof railings and two crosspieces.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

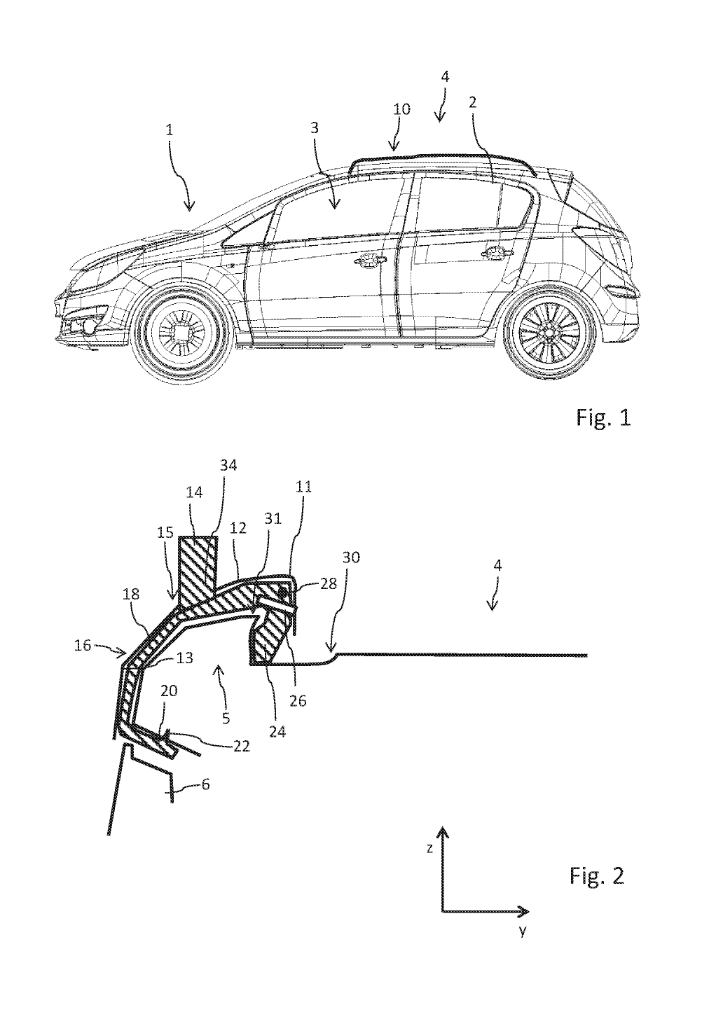

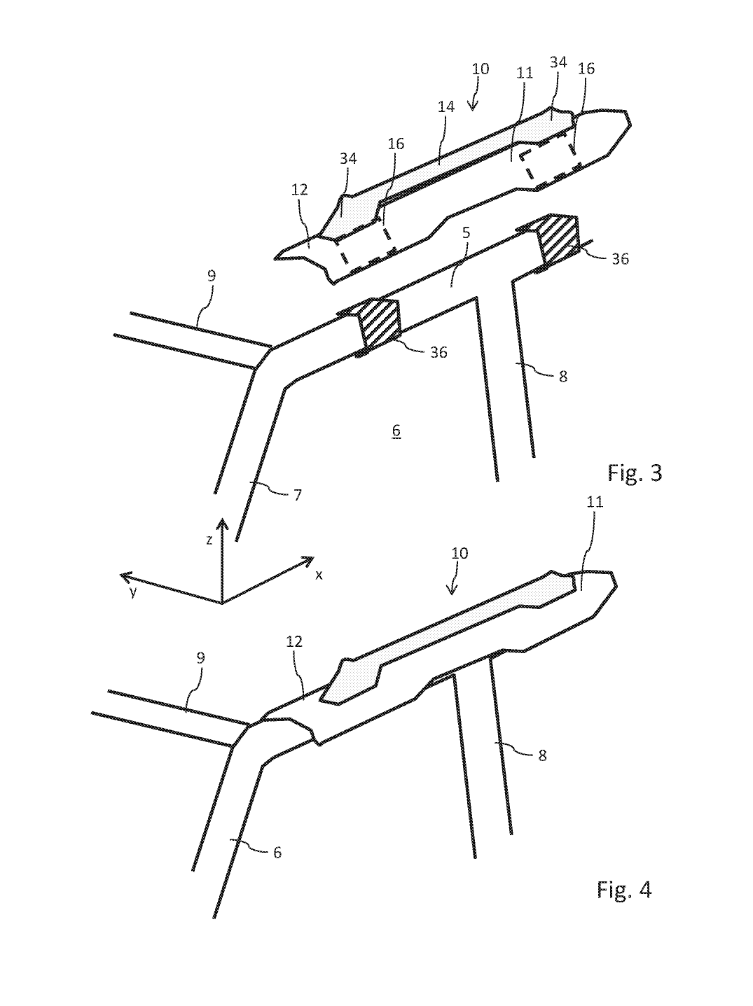

The motor vehicle 1 illustrated in FIG. 1 includes an integral motor vehicle body 2. The motor vehicle body 2 forms a passenger compartment 3 for passengers of the motor vehicle. The motor vehicle body 2 furthermore includes a vehicle roof 4 with a left and a right roof frame 5. According to the perspective view in FIG. 3, the lateral roof frame 5, in this case the left roof frame, extends in the longitudinal direction (x) of the vehicle. It transforms into a downwardly extending A-column 7 toward the front referred to the driving direction of the motor vehicle 1. The roof frame 5 transforms into a B-column 8, which essentially extends vertically downward, adjacent to the rear end of a front side door 6.

The roof frames 5 arranged symmetrically or equally on the left and the right edge of the roof 4 are structurally connected to one another above a front window by a front cross member 9 as indicated in FIG. 3. A corresponding cross member naturally is also provided on the rear end of the roof frame.

A roof railing 10 can be detachably arranged on the left roof frame 5 illustrated in FIG. 3. The roof railing 10 includes a longitudinally extending roof ledge 14, as well as a cover 12 that likewise extends longitudinally. The cover 12 has an upper side 11 that faces the viewer and is visible from outside in the illustrations in FIGS. 3 and 4. On its underside 13 that faces away from the upper side 11, the cover 12 includes at least two mounting elements 16 that are spaced apart from one another in the longitudinal direction (x). The spacing between the mounting elements 16, which are merely illustrated with broken lines in FIG. 3, corresponds to the spacing between defined mounting structures 36 on the roof frame 5.

The mounting elements 16 of the roof railing can be detachably connected to the respective mounting structures 36 of the roof frame 5 provided for this purpose in order to detachably mount the roof railing 10 on the roof 4 of the motor vehicle body 2.

The region of the roof frame 5 located between the mounting structures 36 can be completely or at least sectionally covered by the cover 12. The cover 12 may be realized, for example, in the form of a plastic or sheet metal shell. Its upper side 11, in particular, may have a color and surface contour that respectively provide the roof 4 and the entire motor vehicle 1 with a shapely design that corresponds to the respective specifications. The roof ledge 14, which is spaced apart from the upper side 11 of the cover 12, can also meet various design requirements and accordingly have a configuration-specific contour or geometry. The longitudinally extending roof ledge 14 may also be realized in many different ways with respect to its color, surface quality and material selection. The roof ledge 14 may also completely rest against the cover 12 over its entire length.

The roof ledge 14 is directly and structurally connected to the at least two mounting elements 16. In this way, the roof ledge can be detachably mounted on the roof frame 5 in the form of a load-bearing structural component. According to FIG. 2, the roof ledge 14 penetrates a precisely fitted recess 15 of the cover 12 with a downwardly protruding connecting web 34 provided on its longitudinal end. The roof ledge 14 therefore is directly connected to the mounting element 16 by the connecting web 34.

According to the cross section illustrated in FIG. 2, the mounting element 16 includes a holding clamp 18 with C-shaped cross section in this embodiment. This holding clamp includes a lower limb 20 and an opposite upper limb 24 on its free ends. An upwardly protruding projection 22 is provided on the lower limb 20 and can be inserted into an installation opening on the roof frame 5 provided for this purpose in order to produce the connection with the roof frame 5.

The lower limb 20 can be inserted, in particular, into a clearance between the roof frame 5 and an upper edge of a side door 6. A region of the holding clamp 18, which is visible from outside in the installed position, is completely covered by the cover 12 such that the mounting element 16 is not visible from outside in its final installation position on the roof frame 5 illustrated in FIG. 2.

For example, the upper and the lower limb 24, 20 may be arranged such that they can be moved or pivoted relative to one another about a pivoting axis 28. In this way, the clearance between the free ends of the upper limb 24 and the lower limb 20 can be varied. At least one of the limbs 24, 20 may be provided with a fixing element 26, by which the alignment or position of the limbs 20, 24 relative to one another can be varied, as well as locked and fixed.

The fixing element 26 may be realized, for example, in the form of a threaded fastener that can be actuated with a wrench provided for this purpose. For example, the fixing element 26 may be realized in the form of a hexagon threaded socket fastener that can be turned with a corresponding wrench. In this way, the alignment of the limbs 20, 24 relative to one another can be varied such that the profile of the roof frame 5 can be enclosed by the holding clamp 18 positively and/or non-positively, particularly in a clamped fashion.

It is particularly provided that the free end of the upper limb 24 ultimately lies in a lateral channel, for example in a water drainage channel on the lateral roof edge. The channel 30 respectively transforms into the roof frame 5 or into the profile of the roof frame outward in the lateral direction (y) of the vehicle in the form of an undercut region 31. When the holding clamp 18 is in its closed position, its upper limb 24 can engage behind the undercut region 31 in order to fix the mounting element 16 on the roof frame 5 positively and/or non-positively, i.e. in a clamped fashion.

The shell-like cover 12 essentially may completely rest against the roof frame 5 in its installed position on the motor vehicle.

A roof railing 10 installed on the motor vehicle 1 can be replaced with a different type of roof railing 10 at any time by providing a set of various roof railings 10. The roof railings of a roof railing set differ from one another with respect to their color, contour, material or surface quality. However, they always include identical mounting elements such that a defined connection can be produced on the roof frame.

The roof frame 5 itself is always realized identically regardless of the selection of a certain roof railing. In this respect, an individual design of the roof railing region of the motor vehicle body requires no adaptation of the roof frame 5 whatsoever. In this way, the production and assembly costs for the manufacture of the car body shell can be advantageously lowered.

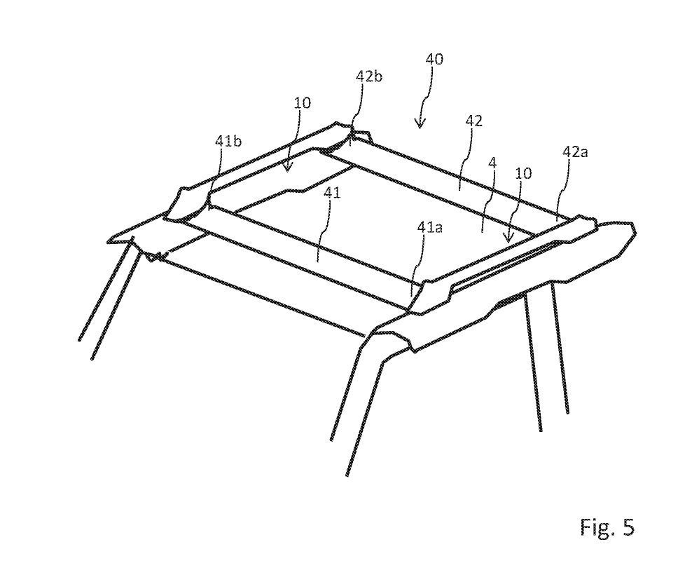

FIG. 5 furthermore shows a roof rack arrangement 40. This roof rack arrangement includes two roof railings 10 that are arranged on opposite roof edges and extend parallel to one another. The roof railings are arranged on the roof 4 of the motor vehicle at approximately the same height referred to the longitudinal direction (y) of the vehicle. In this case, the two roof railings 10 are furthermore connected to one another by two crosspieces 41, 42. The crosspieces 41, 42 lie in the plane of the at least for mounting elements 16 of the two roof railings 10. They are directly connected to the mounting elements 16 of the two roof railings 10 with their opposite end sections 41a, 41b and 42a, 42b. Receptacle devices for carrying along roof loads such as bicycles or roof boxes may be arranged on the crosspieces 41, 42.

The crosspieces 41, 42 may be detachably connected to the railings 10. They may be connected to the roof railings 10 provided on the vehicle roof 4 as needed in order to form the roof rack arrangement 40. It would furthermore be conceivable that the crosspieces 41, 42 are not only connected to the mounting elements 16 of the roof railings. Alternatively, the crosspieces 41, 42 may also be permanently or detachably connected to the longitudinally extending roof ledges 14 of the roof railings 10.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A roof railing configured to detachably mount on the roof frame of a motor vehicle comprising:
a longitudinally extending roof ledge;
a longitudinally extending cover having an upper side facing the roof ledge and an underside facing away from the upper side; and
at least two mounting elements spaced apart from one another in the longitudinal direction on the underside of the cover.

17. The roof railing according to claim 16, wherein the mounting elements are structurally connected to the roof ledge.

18. The roof railing according to claim 16, further comprising a connection between the roof ledge and the mounting element penetrating a recess formed in the cover.

19. The roof railing according to claim 16, wherein the cover further comprises a shell-like contour adapted to a lateral roof frame of the motor vehicle.

20. The roof railing according to claim 16, wherein the cover comprises a plastic shell.

21. The roof railing according to claim 16, wherein the cover comprises a sheet metal shell.

22. The roof railing according to claim 16, wherein the roof ledge is spaced apart from the cover and connected to the at least two mounting elements by at least two connecting webs, wherein the at least two mounting elements penetrate the cover.

23. The roof railing according to claim 16, wherein each of the at least two mounting elements comprise a holding clamp corresponding to a mounting structure of the roof frame.

24. The roof railing according to claim 23, wherein the holding clamp comprises an upper limb, a lower limb relatively positionable to the upper limb and a fixing device configured to variably adjust and fix the upper and lower limbs.

25. A roof railing set according to claim 16, further comprising at least two roof railings, wherein the roof railings have identical mounting elements and at least one of different cover configurations or different roof ledges configurations.

26. A roof rack arrangement according to claim 16, further comprising at least two roof railings, wherein the roof railings are arranged parallel to one another and spaced apart from one another perpendicular to a longitudinal direction, and at least one crosspiece extending between the roof railings and having opposite end sections structurally connected to the roof railings.

27. The roof rack arrangement according to claim 26, wherein the at least one crosspiece is directly connected to at least one of the mounting elements of the roof railings.

28. The roof rack arrangement according to claim 27, wherein the at least one crosspiece is detachably connected to the roof railings.

29. The roof rack arrangement according to claim 26, wherein the at least one crosspiece is detachably connected to the roof railings.

30. A motor vehicle comprising a motor vehicle body and a lateral roof frame having at least two mounting structures on which at least one roof rack arrangement according to claim 26 is arranged.

31. The motor vehicle according to claim 30, wherein the mounting structures are clamped to at least one of the mounting elements of a roof railing.

32. The motor vehicle according to claim 30, wherein the cover of the roof railing covers at least the mounting structures of the roof frame in an installed position on the motor vehicle body.
